(19) United States
(12) Patent Application Publication
(10) Pub. No.: US 2018/0186026 A1
(43) Pub. Date: Jul. 5, 2018

(54) CUTTER MACHINE WITH TWO HOT WIRES

(71) Applicant: Procarv, Voiron (FR)

(72) Inventor: M. David Annequin, Colombes (FR)

(21) Appl. No.: 15/846,688

(22) Filed: Dec. 19, 2017

(30) Foreign Application Priority Data
Dec. 29, 2016 (FR) 16 63517

(51) Int. Cl. B26F 3/12

(52) U.S. Cl. CPC B26F 3/12

(57) ABSTRACT

A hot-wire cutter machine comprises a mount (1) that extends in a plane for carrying flat a panel (9) for cutting, and a cutter structure (4) fastened to the mount, which cutter structure is a frame having four sides (4A, 4B, 4C, 4D) between which two crossed cutter wires (5, 6) are tensioned, the frame being fastened inside the mount at two fastening points (P1, P2) that are offset on a line (L) that crosses the frame.

### CROSS REFERENCE TO RELATED APPLICATION

This application claims priority under 35 USC § 119 to French Patent Application No. 1663517 filed on Dec. 29, 2016, which application is hereby incorporated by reference in its entirety.

### TECHNICAL FIELD

The field of the invention is that of hot-wire cutter machines as used in particular on building sites for cutting polystyrene insulation panels.

### PRIOR ART

Such a hot-wire cutter machine is disclosed in patent document DE 20 2013 005772.

That hot-wire cutter machine comprises a mount for carrying a panel that is to be cut, a cutter bow fastened to the mount and presenting two parallel opposite sides between which a cutter wire is tensioned, and an actuator mechanism using a cable and pulleys inside the bow in order to move the tensioned wire in a certain cutting direction perpendicular to the mount.

The bow may be fastened to the mount in pivotal manner in order to make various chamfer cuts.

### SUMMARY OF THE INVENTION

The object of the invention is to improve such a hot-wire cutter machine to facilitate making a wider variety of cuts.

To this end, the invention provides a hot-wire cutter machine comprising a mount that extends in a plane in order to carry flat a panel for cutting, and a cutter structure fastened to the mount and having the cutter wire tensioned thereon, the machine being characterized in that the cutter structure is a frame having four sides between which two crossed cutter wires are tensioned, and in that the frame is fastened inside the mount at two fastening points that are offset on a line that crosses the frame.

The hot-wire cutter machine of the invention may present the following features:
The fastening points may be offset pivots on which the frame is mounted to turn inside the mount.
The frame may be a rectangular frame having two mutually parallel short sides between which a first cutter wire is tensioned that extends parallel to the plane of the mount, and two mutually parallel long sides between which a second cutter wire is tensioned that extends across the plane of the mount.
An actuator mechanism, e.g. using cables and pulleys, may be provided inside the frame for moving said first and second cutter wires in two orthogonal cutting directions.
The mount may include a retractable stand forming an easel, or indeed suspension hooks.

With the arrangement of the invention, and without removing the panel from the mount, it is easy to perform various cuts, in particular U-shaped cuts, in all three dimensions (thickness, width, length) of the panel.

In particular, with the second cutter wire that is tensioned between the two parallel long sides of the mount of the cutter structure, it is possible to make a U-shaped cut over a length of more than 120 centimeters (cm) along the length of a polystyrene insulation panel that is 250 cm long by 120 cm wide.

### BRIEF DESCRIPTION OF THE DRAWINGS

The present invention can be better understood and other advantages appear on reading the following detailed description of an embodiment taken by way of non-limiting example and shown in the accompanying drawings, in which:

FIG. 1 is a diagrammatic view of a cutter machine of the invention having two hot wires;

FIG. 2 is a diagrammatic view of the cutter machine of the invention with a panel cut in its thickness and in its width;

FIG. 3 is a diagrammatic view of the cutter machine of the invention with a panel cut chamfer in the length of the panel;

FIG. 4 shows a fragment of the actuator mechanism for actuating two hot wires in two orthogonal directions; and

FIG. 5 shows the cutter machine of the invention in a folded position.

### DESCRIPTION OF EMBODIMENTS

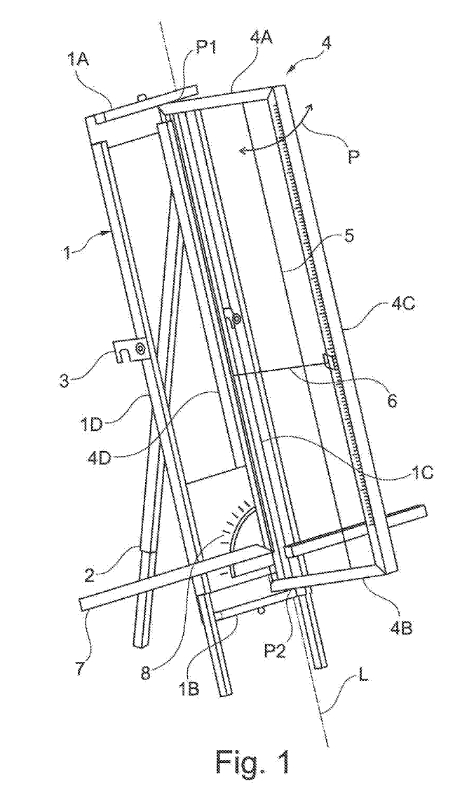

In FIG. 1, the cutter machine of the invention having two hot wires comprises a mount 1 that lies in a plane in order to carry flat a panel for cutting (not shown in FIG. 1), e.g. a polystyrene insulation panel for insulating buildings.

The mount 1 in this example is a tubular mount, e.g. made of aluminum forming a rectangular frame that is mounted on a retractable stand 2 in the form of an easel that is adjustable in height.

In FIG. 1, the mount is in a sloping position, e.g. for work on scaffolding.

The mount may also be provided with suspension hooks 3 (only one being visible in FIG. 1) in order to be suspended from the guard rail of a nacelle, for example.

In the invention, the mount 1 has fastened therein a cutter structure 4 forming a frame, e.g. a rectangular frame, for carrying two crossed cutter wires 5, 6.

The frame of the cutter structure is fastened to the inside of the mount at two fastening points P1 and P2 that are offset along a line L crossing the frame.

More particularly, and as can be seen in FIG. 1, the fastening points P1 and P2 between the two opposite short sides 1A and 1B of the mount and the two opposite short sides 4A, 4B of the cutter structure are offset along a line L that passes between the two opposite long sides 1C, ID of the mount and the two opposite long sides 4C, 4D of the cutter structure.

These two fastening points P1, P2 are preferably pivot points that are offset to enable the frame of the cutter structure to occupy different angular positions relative to the plane of the mount so as to make chamfered cuts in the panel or so as to retract the cutter structure completely into the inside of the frame of the mount.

FIG. 1 shows the rectangular frame 4 of the cutter structure with the two parallel opposite short sides 4A, 4B having tensioned between them the first cutter wire 5, which extends parallel to the plane of the mount, and the two opposite parallel long sides 4C, 4D having tensioned between them the second cutter wire 6, which extends across the plane of the mount and which crosses the cutter wire 5, at right angles in this example, and without making contact therewith.

In practice, the offset of the two pivot points P1, P2 from the long side 4D of the frame of the cutter structure is a few centimeters, e.g. 3 cm, such that the second cutter wire 6 crosses the plane of the mount completely.

The short sides 4A, 4B of the frame of the cutter structure have a length of about 50 cm so as to provide a depth of cut of about 40 cm, while the long sides 4C, 4D of the frame of the cutter structure may have a length of about 150 cm, so as to obtain a length of cut of 135 cm.

Turning of the frame 4 of the cutter structure in the frame of the mount is represented by double-headed arrow P in FIG. 1.

FIG. 1 also shows an angle bar 7 for holding the panel that is to be cut in a horizontal or sloping position on the mount, the angle bar 7 being mounted to be tiltable in the plane of the mount in order to form chamfer cuts.

Reference 8 designates a protractor for measuring the angle of inclination of the angle bar 7 in the plane of the mount.

As can be seen in FIG. 1, the angle bar 7 crosses the plane of the frame 4 of the cutter structure. It is cut facing the offset line L of the pivot points P1, P2 so as to allow the second cutter wire 6 to pass along the full height of the frame 4 of the cutter structure.

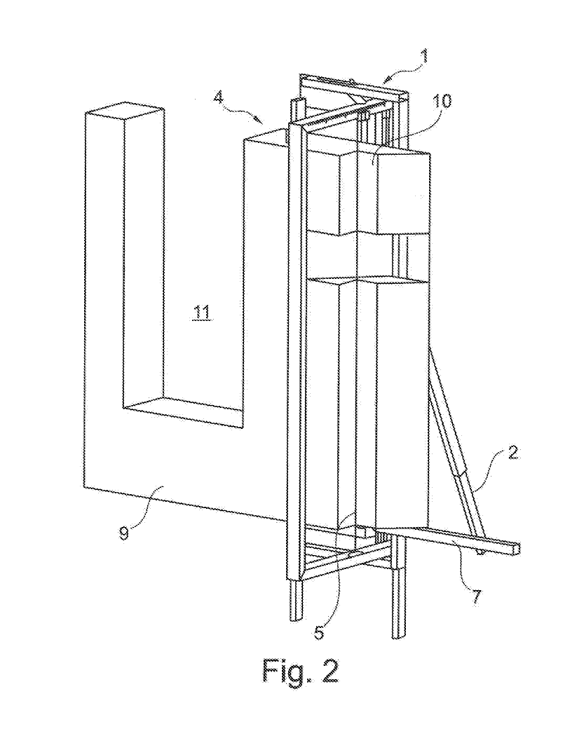

FIG. 2 shows a polystyrene insulation panel 9 placed in the hot-wire cutter machine of the invention having two hot wires.

In this figure, the angle bar 7 is horizontal and the panel 9 extends horizontally lengthwise in the angle bar 7.

FIG. 2 shows a groove 10 formed in the width of the panel using the cutter wire 5 that is tensioned substantially vertically.

In order to make this groove 10, the cutter wire 5 is moved from the front towards the rear of the mount with the frame 4 of the cutter structure at 90° relative to the plane of the mount. Thereafter, the panel 9 is moved from right to left in FIG. 2 while the cutter wire 5 remains stationary in the cutter structure.

There can also be seen a U-shaped notch 11 that has been made in the length of the panel using the cutter wire 6 that is tensioned substantially horizontally.

In order to make this notch 11, the cutter wire 6 is moved downwards. Thereafter, the panel is moved from right to left in FIG. 2 while the cutter wire 6 remains stationary. Finally the cutter wire 6 is moved upwards, the panel remaining stationary on the mount 1.

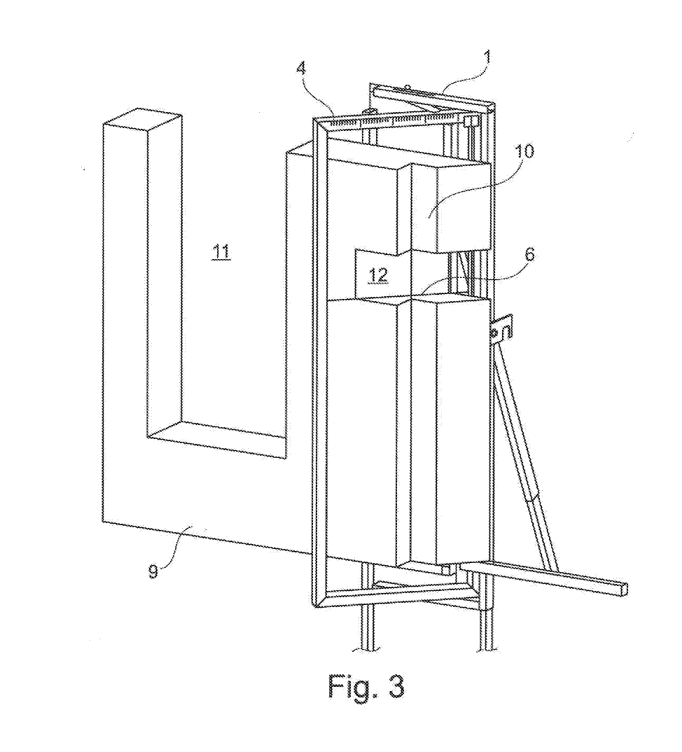

FIG. 3 shows another U-shaped notch 12 that is made so as to be chamfered in the panel 9 by using the cutter wire 6.

In this example, the frame 4 of the cutter structure is sloped at 450 relative to the plane of the mount 1.

In this example, the cutter wire 6 is located at half-height in the frame 4.

The panel 9 is moved from left to right in FIG. 3. Thereafter, the cutter wire 6 is moved upwards, while the panel 9 remains stationary on the mount 1. Finally, the panel 9 is then moved from right to left in FIG. 3, with the cutter wire 6 remaining stationary in the frame 4.

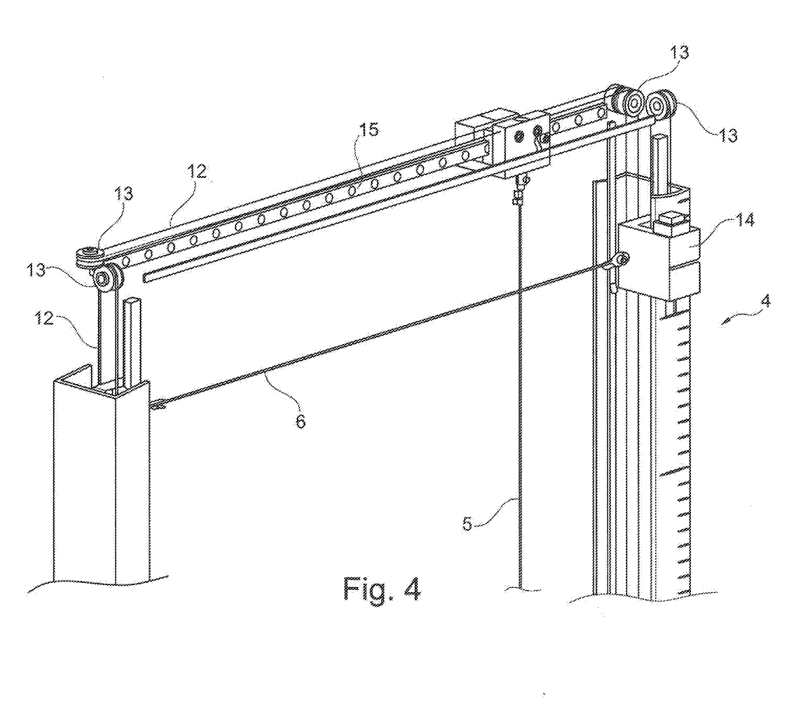

FIG. 4 shows a mechanism having cables 12 and pulleys 13 for moving the cutter wires 5 and 6 that cross in the frame 4 of the cutter structure.

Each of the cutter wires 5 and 6 may be moved by means of a cursor such as 14 sliding along a slideway carrying a millimeter scale.

The cutter wires 5 and 6 may be heated by electricity delivered by a copper track 15 that is stuck to the inside of the frame 4 which has a profiled shape.

Electricity may be stored in a battery fastened to the mount.

The two cutter wires 5 and 6 cross without making contact. They move respectively in two parallel planes of the frame 4 that are spaced apart from each other by 1 cm, for example.

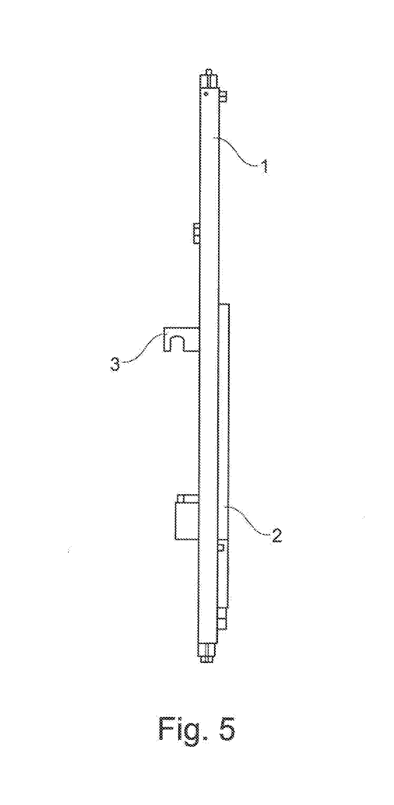

FIG. 5 shows the hot-wire cutter machine of the invention having two hot wires in a folded position when the frame 4 of the cutter structure is retracted into the frame of the mount 1.

In this folded position, the cutter machine of the invention is very compact.

It may be suspended vertically from the guard rail of a shallow nacelle.

This hot-wire cutter machine of the invention having two hot wires is compact because the two cutter wires are movable in a single frame of the cutter structure. The hot-wire cutter machine of the invention having two hot wires may be fabricated at low cost out of welded-together metal tubes.

What is claimed is:

1. A hot-wire cutter machine comprising a mount that extends in a plane in order to carry flat a panel for cutting, and a cutter structure fastened to the mount and having the cutter wire tensioned thereon, wherein the cutter structure is a frame having four sides between which two crossed cutter wires are tensioned, and in that the frame is fastened inside the mount at two fastening points that are offset on a line that crosses the frame.

2. The hot-wire cutter machine according to claim 1, wherein the fastening points are offset pivots on which the frame is mounted to turn inside the mount.

3. The hot-wire cutter machine according to claim 2, wherein the frame is a rectangular frame having two mutually parallel short sides between which a first cutter wire is tensioned that extends parallel to the plane of the mount, and two mutually parallel long sides between which a second cutter wire is tensioned that extends across the plane of the mount.

4. The hot-wire cutter machine according to claim 3, wherein it includes an actuator mechanism inside the frame for moving said first and second cutter wires in two orthogonal cutting directions.

5. The hot-wire cutter machine according to claim 4, wherein the mount includes a retractable stand forming an easel, or suspension hooks.

6. The hot-wire cutter machine according to claim 1, wherein the frame is a rectangular frame having two mutually parallel short sides between which a first cutter wire is tensioned that extends parallel to the plane of the mount, and two mutually parallel long sides between which a second cutter wire is tensioned that extends across the plane of the mount.

7. The hot-wire cutter machine according to claim 6, wherein it includes an actuator mechanism inside the frame for moving said first and second cutter wires in two orthogonal cutting directions.

8. The hot-wire cutter machine according to claim 1, wherein the mount includes a retractable stand forming an easel, or suspension hooks.

9. The hot-wire cutter machine according to claim 2, wherein the mount includes a retractable stand forming an easel, or suspension hooks.

10. The hot-wire cutter machine according to claim 3, wherein the mount includes a retractable stand forming an easel, or suspension hooks.
